(19) United States
(12) Patent Application Publication
(10) Pub. No.: US 2011/0237469 A1
(43) Pub. Date: Sep. 29, 2011

(54) COMPOSITIONS AND METHODS FOR INHIBITING EMULSION FORMATION IN HYDROCARBON BODIES

(75) Inventors: Chandrashekhar Khandekar, Houston, TX (US); Rohan Wilson, Bentley (AU); James Smith, Bentley (AU)

(73) Assignees: M-I AUSTRALIA PTY LTD., Perth (AU); M-I SWACO NORGE AS, Stavanger (NO)

(21) Appl. No.: 13/058,417

(22) PCT Filed: Jul. 29, 2009
(86) PCT No.: PCT/AU09/00985

§ 371 Date: Jun. 8, 2011

(30) Foreign Application Priority Data
Aug. 11, 2008 (AU) 2008904086

(51) Int. Cl. C09K 8/52

(52) U.S. Cl. 507/235; 507/246

(57) ABSTRACT

A composition for inhibiting the formation of an emulsion between naphthenic acid and metal ions in a hydrocarbon body, the composition including at least one alkoxylated amine in an amount of up to 30% w/w, at least one acid in an amount of from 2 to 10% w/w and at least one alcohol in an amount of from 30 to 70% w/w. A method for inhibiting the formation of an emulsion between naphthenic acid and metal ions in a hydrocarbon body using such a composition is also proposed.

### FIELD OF THE INVENTION

The present invention relates broadly to the inhibition of emulsion formation in hydrocarbon bodies. In particular, the invention relates to compositions for inhibiting the formation of emulsions, such as sodium carboxylate emulsions, during hydrocarbon extraction. For example, in the near well bore and well bore, or in process equipment such as separators and chemical-electric dehydrators. The invention further relates to methods for inhibiting such emulsions from occurring utilising the compositions of the invention.

### BACKGROUND TO THE INVENTION

The formation of precipitates or emulsions in crude oil during extraction and processing presents a plethora of problems. For example, the formation of stabilized emulsions delays the production of oil for future sale and use, and also has a deleterious effect on the sales quality of the oil. Overall, the formation of precipitates and emulsions in crude oil decreases the efficiency of extraction, processing and refinement processes.

The formation of precipitates or emulsions in crude oil generally results from the reaction of metal cations with indigenous naphthenic acids. In this context, naphthenic acids are generally considered to be complex mixtures of alkyl-substituted acyclic and cyclic carboxylic acids that are generated from in-reservoir biodegradation of petroleum hydrocarbons. They are normal constituents of nearly all crude oils and may be present in amounts of up to 4% by weight. They are predominantly found in immature heavy crudes, whereas paraffinic crudes normally have lower naphthenic acid contents. Metal cations found in crude oil that are involved in precipitate and emulsion formation include alkali and alkaline-earth metals such as sodium, potassium, calcium and magnesium. Transition metals such as iron may also be involved.

There are two common types of precipitate/emulsion that are formed as a result of the reaction between metal ions and naphthenic acids in crude oil:

### (1) Calcium Naphthenates

These are generated from heavy crude oils with high levels of tetraprotic carboxylic acids and are formed as a result of a reaction between a naphthenic acid and a calcium cation. The properties of calcium naphthenates pose unique challenges in terms of flow assurance such as:
plugging of chokes, valves, pumps and vessel internals;
blocking of water legs in separators due to migration into the water phase;
unplanned shutdowns due to hardened deposits causing blockages;
disposal issues due to presence of heavy metals which can lead to high NORM activity;
negative impact on water quality due to an increased oil content in the separated water; and
negative impact on injection/disposal well performance.

### (2) Sodium Carboxylates

These are generated by the reaction of monocarboxylic acids in crude oil and sodium ions in the water phase and are often referred to as carboxylate soaps. They produce flow assurance challenges that are different to calcium naphthenates, in particular:
they form ultra stable viscous emulsions which accumulate at the interface of the oil and water components in a separator thereby reducing the residence time and efficiency of separation;
sludges of carboxylate soaps can reduce storage and export tank capacity making it difficult for removal from the tanks;
toxic sludges may be produced; and
oil-wet soap particles may be discharged in the separated water.

It is recognised that naphthenic acid salts, commonly referred to as “soaps” in the oil industry, are present in a variety of hydrocarbon sources. The issue is believed to be predicated by high Total Acid Number (TAN), indicating significant amounts of naphthenic acid specified by the general formula R—COOH, but more specifically described in the literature as carboxylic acids of cyclic and acyclic types as noted above.

When exposed to precise conditions, naphthenic acids partition from the oil phase to the aqueous phase. The main factors believed to play a role in “soap” formation can be divided into production chemistry issues of crude oil composition, connate water and pH variations and physical parameters such as pressure, temperature, co-mingling of fluids, shear, and water-cut. The partitioning of naphthenic acids under precise conditions may lead to production problems, including solids formation and emulsification, at the reservoir wellbore interface and throughout the surface facilities, such as pipelines and separators (i.e. as listed above).

The formation of sodium carboxylate soaps and their subsequent precipitation results in a tight emulsion incorporating solids, as discussed above. The precipitation may cause major processing disruptions and/or upsets in the production process, and thereby inhibit sale of crude oils.

Hence, the present invention in certain embodiments relates to inhibiting the formation of sodium carboxylate soaps (i.e. emulsions) from pH 5.9 to 7.5 during fluid extraction and processing alleviating or avoiding the need for subsequent acid treatment to mitigate the damage caused by these materials.

Sodium carboxylate “soaps” are formed by contact of acidic crude oil with high pH brine or similar aqueous media. Sources of water effective in naphthenate soap formation include the connate water present in the reservoir, water injected for secondary recovery purposes, filtrate or the water entrained as a result of the water conning phenomenon. The prompting process for the formation of sodium carboxylate soap is the contact of acidic crude and fluid are described in the following.

With regard to the reaction chemistry within the system, the formation water is usually saturated with CO₂ establishing an equilibrium under the reservoir pressure, temperature, and brine pH conditions. Carbon dioxide (CO₂) contained in formation fluids in the reservoir controls the system pH. CO₂ dissociates to bicarbonate and further into carbonic acid during production transmittal. As a result of pressure decreases, the pH of the water increases beyond a threshold pH of 5.9 to 6.2 allowing the carboxylic acids in the crude oil to dissociate leading to partition to some degree into the water phase where they may react with sodium cations to form soap. The change in pH is deemed a function of pressure decrease related to CO₂ content.

Hence, the H⁺ concentration decreases and equilibrium shifts as the pressure drop triggers the degassing of CO₂ during the flow of fluids under a pressure gradient, for example lifting from a high pressure well bore to a low pressured process facility. This reduction in the protons yields increases in the pH of the water.

Various chemical additives have been used to mitigate the formation of precipitates or emulsions in crude oil. For example, US 2005/0282711 A1 and US 2005/0282915 A1 (both to Ubbels et al.) disclose surfactant compositions containing hydrotopes such as mono- and diphosphate esters and methods for inhibiting the formation of naphthenate salts at oil-water interfaces. WO 2007/065107 A2 (Baker Hughes Inc.) discloses a method for inhibiting the formation of naphthenic acid solids or emulsions in crude oil in and/or downstream from an oil well.

### SUMMARY OF THE INVENTION

In a first aspect of the invention there is provided a composition for inhibiting the formation of an emulsion between naphthenic acid and metal ions in a hydrocarbon body, the composition including at least one alkoxylated amine in an amount of up to 30% w/w, at least one acid in an amount of from 2 to 10% w/w and at least one alcohol in an amount of from 30 to 70% w/w.

As already noted, in the context of hydrocarbon bodies, such as crude oil reservoirs, “naphthenic acid” includes a complex mixture of carboxylic acids. Consequently, the term should be read as such in this specification and should not be construed as particularly limited. The naphthenic acid may be present in its acidic neutral form or may be dissociated into naphthenate anions. Generally, the naphthenic acid is dissociated into naphthenate anions.

The metal cation taking part in the emulsion is generally an alkali metal or an alkaline earth metal. More particularly, the metal cation will generally be a sodium, potassium, calcium or magnesium cation.

The emulsion predominantly contains sodium carboxylate species formed from naphthenic acid, which may be in the form of naphthenate anions as discussed above, and sodium cations.

The alkoxylated amine utilised in the composition may be a tertiary or quaternary alkyl-substituted amine wherein the alkyl groups have been further substituted with one or more alkoxyl groups. Optionally, the alkyl groups may also be substituted with one or more tertiary amino groups which may also be substituted with alkoxyl groups. Preferred alkoxyl groups of the invention include methoxyl, ethoxyl and propoxyl groups. In addition, the alkoxyl groups may also be substituted with one or more hydroxyl groups. The hydroxyl groups may be located at the termini of the alkoxyl groups. For example, alkoxylated amines for use in the present invention may have the following structure:

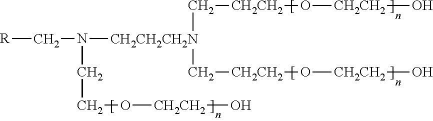

wherein R represents an alkyl chain having between one and ten carbon atoms and n is any integer between 1 and 8.

Other alkoxylated amines for use in the present invention have the following structure:

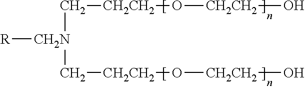

where R represents an alkyl chain having between one and ten carbon atoms and n is any integer between 1 and 8.

Further alkoxylated amines suitable for use in the present invention are those with the following structure:

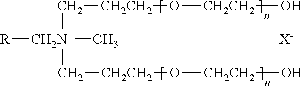

where R represents an alkyl chain having between one and ten carbon atoms, X represents a halogen, nitrate, phosphate, or acetate group and n is any integer between 1 and 8.

Additional examples of alkoxylated amines suitable for use in the present invention include alkyldiamine ethoxylates, tallowalkylamine ethoxylate propoxylates. Other examples include mixtures of alkoxylated fatty amines with carbon chain length from C₁₀-C₂₄, preferably C₁₄-C₁₈ and fatty amines with carbon chain length between C₁₂-C₂₄, preferably C₁₄-C₁₈ (e.g. Armorhib-28 by Akzo Nobel).

Other examples of alkoxylated amines suitable for use in the present invention include quaternary amines of the type:

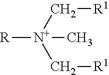

where R¹ is (CH₂CH₂O)ₙH and R is a saturated or unsaturated alkyl chain with carbon numbers varying from C₁₀-C₁₆, more preferably from C₁₀-C₁₃, and having an average number of ethoxylate units of from 10 to 20, more particularly from 3-18 (e.g. Armohib-31 by Akzo Nobel).

Preferably the alkoxylated amine is an alkoxylated rosin amine or Rosin Amine D. The alkoxylated rosin amine and Rosin Amine D for use in the present invention may, for example, have one or more of the following formulae:

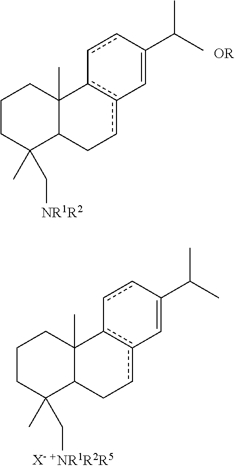

where [symbol] represents a single or double bond; R¹, R² and R⁵ each independently represent H, alkyl, alkenyl or alkynyl group each having between one and ten carbon atoms, —(R³O)ₙR⁴ wherein R³ is an alkyl group having 1 to 3 carbon atoms and R⁴ is H or an alkyl group having 1 to 3 carbon atoms with the proviso that at least one of R¹, R² and R⁵ is an —(R³⁰)ₙR⁴ group; n is an integer between 1 and 11; X is a halide, sulphate, phosphate, nitrate or acetate ion.

A specific example of a suitable alkoxylated rosin amine is RAD 1100 by Akzo Nobel.

The composition contains up to 30% w/w of the alkoxylated amine. Preferably the alkoxylated amine is present in an amount of from about 2 to 15% w/w.

The acid of the composition of the invention is preferably a weak acid to adjust formulation pH below the assumed sodium carboxylate threshold pH of 5.7 to 6.2. For example, the acid may be selected from the group consisting of phosphoric acid, formic, glycolic, propionic butyric, and acetic acid.

Whilst the alcohol used in the composition of the invention is not particularly limited, in a preferred embodiment the alcohol is selected from methanol and isopropanol.

The composition may also include further additives, particularly demulsifiers. For example, the composition may also include an alkylene oxide block polymer demulsifier with a relative solubility in the range of from 5 to 7, such as Majorchem DP-314, an alkyl phenol/formaldehyde resin ethoxylate demulsifier with a relative solubility in the range of from 7 to 9, such as Majorchem DP-282, and/or a diepoxide demulsifier intermediate with a relative solubility in the range of from 5 to 6.5, such as M-I Spec 614.

Still further, it is envisaged that the compositions of the invention may also be blended with other forms of inhibitors, such as hydrate inhibitors. If blended with the compositions of the invention, the hydrate inhibitors are not particularly limited. For example, these may include thermodynamic inhibitors such as methanol, kinetic hydrate inhibitors and low dose hydrate inhibitors.

Without wanting to be bound by theory, it is believed that the alkoxylated amine component of the composition reacts irreversibly with precursors to the emulsions that may form in the hydrocarbon body on rising pH due to change in pressure. Hence, emulsion intermediates form that remain in solution even with rising pH.

In a second aspect of the invention there is provided a method for inhibiting the formation of an emulsion between naphthenic acid and metal ions in a hydrocarbon body including contacting a composition including at least one alkoxylated amine in an amount of up to 30% w/w, at least one acid in an amount of from 2 to 10% w/w and at least one alcohol in an amount of from 30 to 70% w/w with the hydrocarbon body simultaneously with or prior to deprotonation of the naphthenic acid.

Preferably, the composition is contacted with the hydrocarbon body downhole at a relatively acidic pH below 5.7 and prior to deprotonation of the naphthenic acid.

The composition (or compositions if more than one) is preferably added to the hydrocarbon body in an amount of up to about 1000 ppm, more preferably between 100 and 500 ppm.

The rate of separation of aqueous and oil phases is greatly enhanced by the compositions of the invention relative to untreated oil samples. In particular, complete separation generally occurs within 30 minutes of addition of the composition to an emulsion formed between an oil phase and a slightly acidic aqueous phase (typically about pH 6.2 or lower). When the aqueous phase has a slightly basic pH (typically about 8.4) the rate of separation is slower relative to an acidic aqueous phase yet is still improved over an untreated sample.

Contact of the composition with the hydrocarbon body may be performed at any suitable temperature. Preferably, the composition is contacted with the hydrocarbon body at a temperature of from about 40 and 100° C., and more preferably at about 65 to 80° C.

It is envisaged that in certain circumstances emulsions may begin to form as pressure decreases, even though the composition of the invention has been employed. If so, the method may include a secondary treatment including contacting the hydrocarbon body at a point where an emulsion has formed with a composition including at least one alkoxylated amine in an amount of up to about 5% w/w, at least one acid in an amount between about 30 to 80% w/w and at least one alcohol in an amount between about 10 to 60% w/w.

In a third aspect of the invention there is provided a method for treating a hydrocarbon body downhole including introducing a composition including at least one alkoxylated amine to the hydrocarbon body downhole in an amount sufficient to inhibit sodium carboxylate emulsion formation whilst enabling a shift in pH to above about 6.2 in the hydrocarbon body.

Preferably, the composition includes at least one alkoxylated amine in an amount of up to 30% w/w, at least one acid in an amount of from 2 to 10% w/w and at least one alcohol in an amount of from 30 to 70% w/w. That is, the composition is preferably that according to the first aspect of the invention. Other features and embodiments as discussed above will therefore equally apply to the third aspect of the invention. Generally, the composition will be dispersed in the hydrocarbon body.

Embodiments of the invention will now be discussed in more detail with reference to the drawings and examples which are provided for exemplification only and which should not be considered limiting on the scope of the invention in any way.

### BRIEF DESCRIPTION OF THE DRAWINGS

FIG. 1 is a photograph of a series of tubes each of which contains an emulsion formed between crude oil and synthetic water wherein the water phase was treated with acetic acid to provide a pH of 6.3;

FIG. 2 is a photograph of the tubes in FIG. 1 after each was treated, shaken vigorously by hand then placed in a water bath at 74° C. for 30 minutes. Key to tubes and compositions: 1. blank, 2. Secondary Formulation A 250 ppm, 3. Secondary Formulation B 250 ppm, 4. Formulation A 100 ppm, 5. Formulation A 250 ppm, 6. Formulation B 250 ppm;

FIG. 3 is a photograph of the tubes in FIG. 2 after addition of 100 ppm of Secondary Formulation B to each tube followed by vigorous shaking and water bath treatment at 74° C. for 10 minutes;

FIG. 4 is a photograph of a series of tubes, each containing a sample of mid level oil collected from the tubes depicted in FIG. 3 after centrifuging for 10 minutes;

FIG. 5 is a photograph of a series of tubes each of which contains an emulsion formed between crude oil and synthetic water prior to which formation the water phase was treated with sodium acetate and the oil phase of tubes 6 to 8 was pre-treated at 74° C. with a composition. In tubes 1 to 4 the emulsion was formed before adding the composition. Key to tubes and compositions: 1. blank, 2. Formulation B 250 ppm, 3. Formulation A 250 ppm, 4. Secondary Formulation B 250 ppm, 6. Formulation B 250 ppm total fluids, 7. Formulation A 250 ppm total fluids, 8. Secondary Formulation B 250 ppm total fluids;

FIG. 6 is a photograph of the tubes in FIG. 5 after each was shaken vigorously and allowed to settle in a water bath at 74° C. for 30 minutes;

FIG. 7 is a photograph of the tubes in FIG. 6 after addition of 100 ppm of Secondary Formulation B to each tube followed by vigorous shaking and water bath treatment at 74° C. for 10 minutes;

FIG. 8 is a graph of the daily water percentage observed in crude oil samples when a composition Formulation B was injected daily into two individual oil wellheads (B-X3 and B-X4);

FIG. 9 is a graph of the daily emulsion percentage observed in crude oil samples when Formulation B was injected daily into two individual oil wellheads (B-03 and B-04);

FIG. 10 is a photograph of four crude oil samples obtained from two individual oil wellheads (B-X3 and B-X4) prior to commencing daily injection of Formulation B into the wellheads. Key to tubes: 1. sample from well head B-X3 (100%), 2. sample from well head B-X3 (50% with toluene), 3. sample from well head B-X4 (100%), 4. sample from well head B-X4 (50% with toluene);

FIG. 11 is a photograph of a crude oil sample (100%) obtained from wellhead B-X3 after 7 days injection of Formulation B into the wellhead; and

FIG. 12 is a photograph of a crude oil sample (100%) obtained from wellhead B-X4 after 7 days injection of Formulation B into the wellhead.

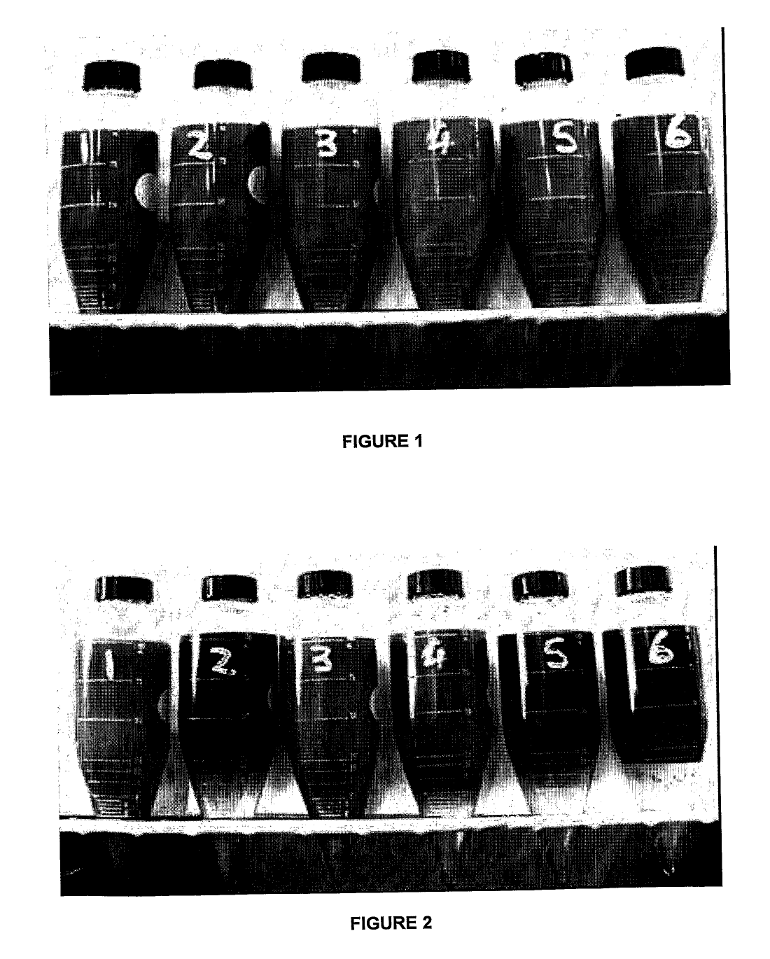

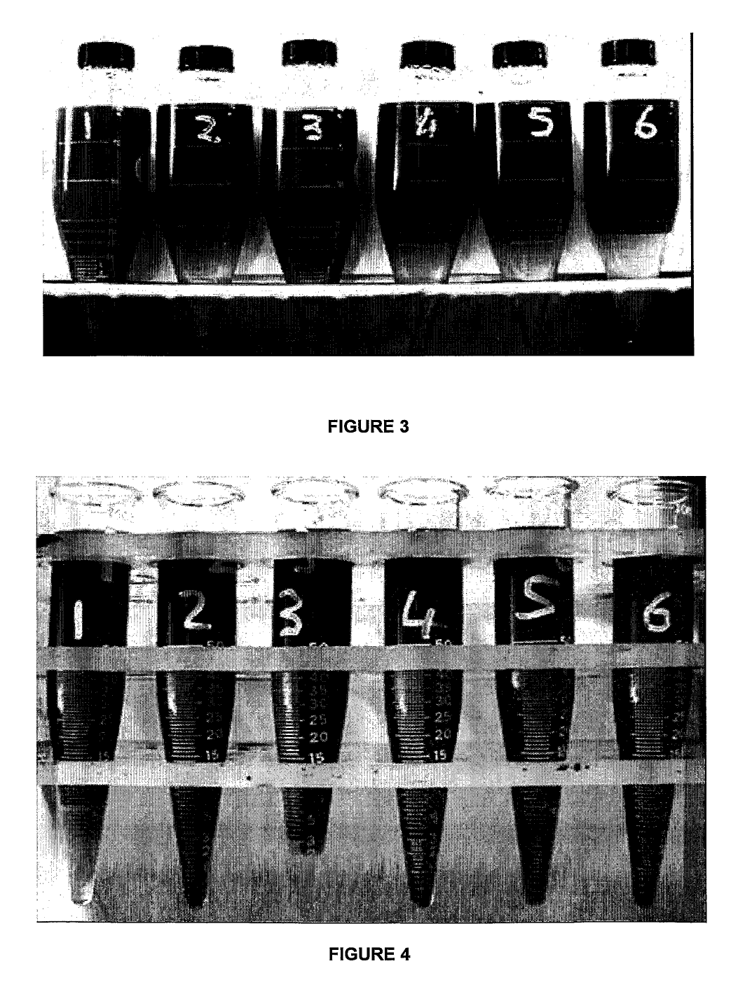

### EXAMPLES

TABLE 1
Compositions of the invention including their % constituents.

| Constituent | Amount | Formulations |
|---|---|---|
| ArMohib ™ 28 or | 2.0-9.5 | A, B, A*, B* |
| Witco RAD 1100 | | |
| Armohib ™ 31 | 2.0-2.5 | A*, B* |
| Isopropanol or methanol | 20-50 | A, B, A*, B* |
| Isopropyl amine dodecyl | 3 | A* |
| benzene sulphonic acid | | |
| Additional Demulsifier | 5-35 | A, B, A*, B* |
| Phosphoric acid or acetic | 9-75 | A, B, A*, B* |
| acid | | |

*Denotes a secondary formulation suitable for secondary treatments post formation of emulsion in the system.

The synthetic water utilised in Examples 1 and 2 was initially prepared in order to mimic the total dissolved solid content of onsite water obtained from previous analysis. The water was then divided into two batches. The first batch was treated with sodium acetate to raise the pH to 8.4 (predicted to be suitable for topside treatment of oil samples) and heated to 74° C. for use in Example 1. The second batch was treated with acetic acid to lower the pH to 6.3 (the predicted down hole pH) and heated to 74° C. for use in Example 2.

### Example 1

In this example, the effect of introducing compositions into the oil prior to emulsion formation was compared with the effect of introducing the compositions after formation of the emulsion. The water used for this test was made up with sodium acetate.

The contents of the tubes were as follows:

### Tube 1—Blank

Tube 2—Formulation B (250 ppm)
Tube 3—Formulation A (250 ppm)
Tube 4—Secondary Formulation B (250 ppm)
Tube 6—Formulation B injected into oil first (250 ppm total fluids)
Tube 7—Formulation A injected into oil first (250 ppm total fluids)
Tube 8—Secondary Formulation B injected into oil first (250 ppm total fluids)

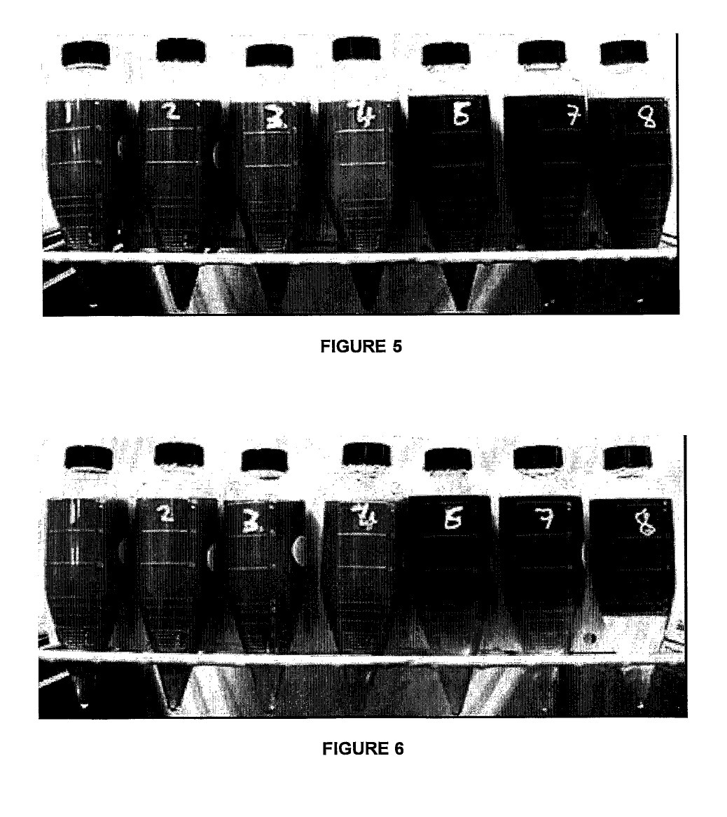

An appropriate quantity of synthetic water at 74° C. and a sample of crude oil (also at 74° C.) were blended for 30 seconds at 10000 rpm (prior to blending the particular composition as detailed above for tubes 6, 7 and 8 was added to the crude oil). The resultant emulsion was shaken by hand while allowed to cool to room temperature. A photograph of the emulsion obtained is shown in FIG. 5.

The particular composition was then added to tubes 2 to 4. All tubes were shaken vigorously by hand and placed in a water bath at 74° C. for 30 minutes. Extensive water separation was observed in tubes 6, 7 and 8 (FIG. 6).

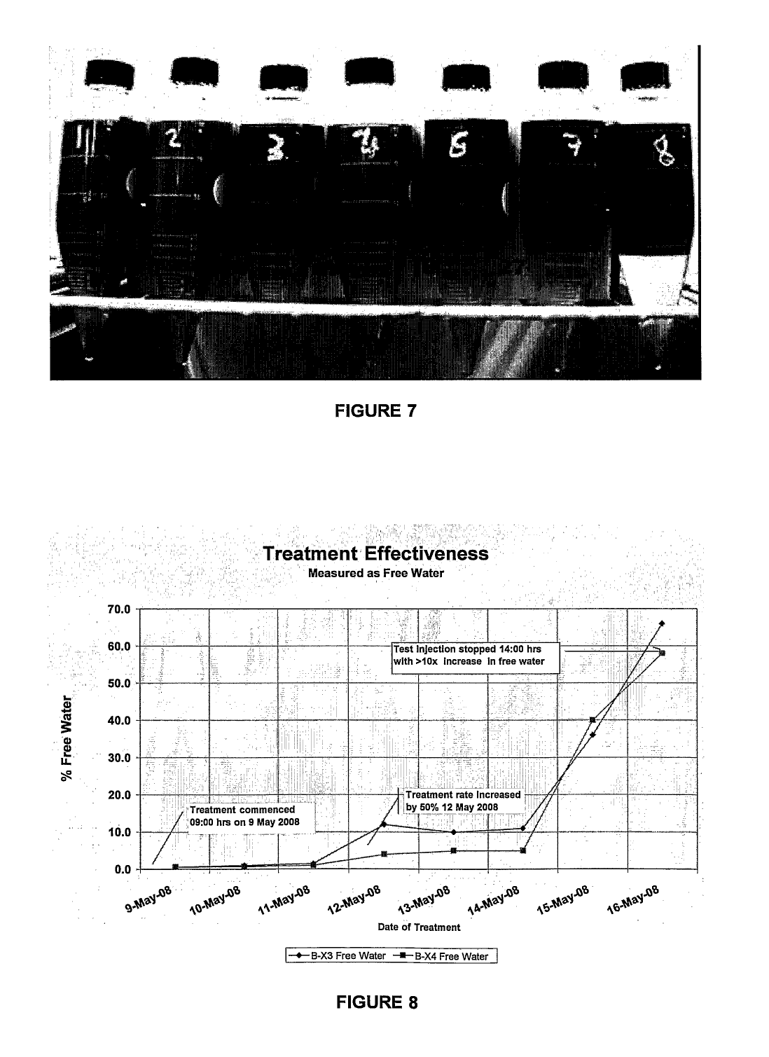

Next, 100 ppm of the acid demulsifier Secondary Formulation B was added to each tube. The tubes were shaken vigorously 50 times and placed in a water bath at 74° C. for 10 minutes. Significant water separation in tube 3 was observed (FIG. 7).

### Example 2

Fluid from two individual wellheads (designated B-X3 and B-X4) located offshore Indonesia were treated with Formulation B over a 9 day period.

On the morning of day 1, the fluids from B-X3 were treated with 235 parts per million (ppm) and fluids from B-X4 were treated with 192 parts per million (ppm) of Formulation B. However, this was subsequently increased to 352.5 parts per million (ppm) for B-X3 and 288 parts per million ppm for B-X4 4 hours later. Based on the sampling results, on day 5 the injection rates were increased from 467 parts per million (ppm) for B-X3 and 384 parts per million ppm for B-X4 until the trial was completed.

Crude oil samples were collected daily. Initially, the sample was centrifuged without heating. The total BS&W, water, emulsion and sediment levels were measured to determine the resolution of the emulsion.

Next, the sample was treated with a conventional demulsifier, shaken and heated in the water bath at 60° C. for 10 minutes. The sample was then centrifuged and BS&W, water, emulsion and sediment is recorded again.

The levels of oil, water, emulsion and sediment measured in well head B-X4 are presented in Table 2.

Table 2 Daily levels of oil, water, emulsion and sediment as measured in crude samples from wellhead B-X4.

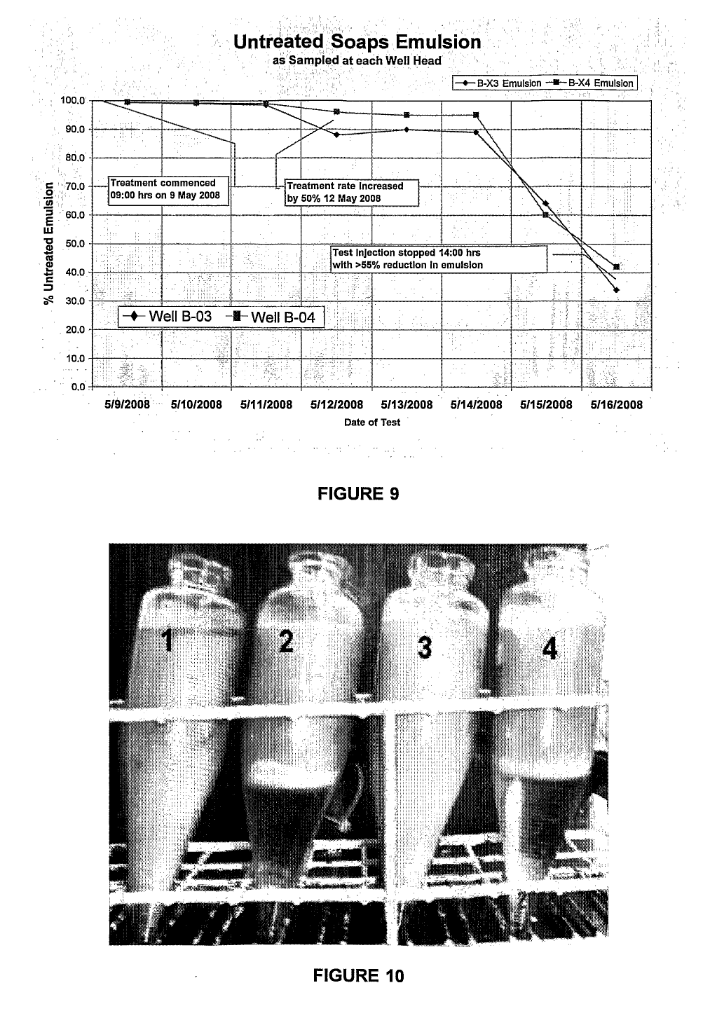

FIGS. 8 and 9 depict the water % and emulsion % respectively for the samples collected daily from the wellheads. Clearly as the trial progresses, the observed water % increases and the observed emulsion % decreases. This can also be seen qualitatively in the photographs of FIGS. 10 and 12. FIG. 10 shows a series of tubes with crude oil samples taken before day 1 of the trial from the individual wellheads as follows:

### 1. Sample B-X3 (100%)

2. Sample B-X3 (50% with toluene)

### 3. Sample B-X4 (100%)

4. Sample B-X4 (50% with toluene)

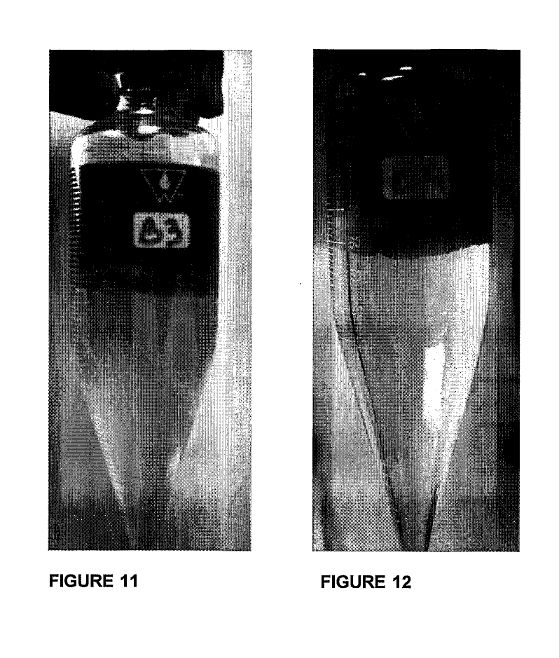

FIGS. 11 and 12 show crude oil samples (100%) taken from wellheads B-X3 and B-X4 respectively 7 days after commencement of the trial. Extensive separation of the oil and water phases is readily apparent relative to the sample tubes 1 and 3 of FIG. 10 taken before commencement of the trial.

Based on the 9 day field trial, the down-hole injection of Formulation B has shown a positive reduction in the amount of soap at the surface sample point and displays the ability to control that emulsion with a residual pH topside of below 7.4.

It will of course be realised that the above has been given only by way of illustrative example of the invention and that all such modifications and variations thereto as would be apparent to persons skilled in the art are deemed to fall within the broad scope and ambit of the invention as herein set forth.

1. A composition for inhibiting the formation of an emulsion between naphthenic acid and metal ions in a hydrocarbon body, the composition including at least one alkoxylated amine in an amount of up to 30% w/w, at least one acid in an amount of from 2 to 10% w/w and at least one alcohol in an amount of from 30 to 70% w/w.

2. The composition of claim 1, wherein the at least one alkoxylated amine includes an alkoxylated rosin amine or Rosin Amine D.

3. The composition of claim 2, wherein the alkoxylated rosin amine has one or more of the following formulae: 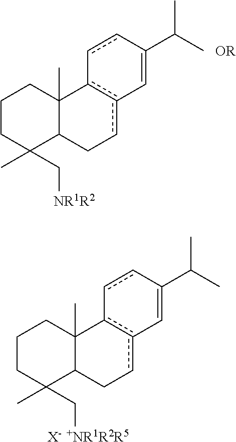
where [symbol] represents a single or double bond; R¹, R² and R⁵ each independently represent H, alkyl, alkenyl or alkynyl group each having between one and ten carbon atoms, —(R³O)ₙR⁴ wherein R³ is an alkyl group having 1 to 3 carbon atoms and R⁴ is H or an alkyl group having 1 to 3 carbon atoms with the proviso that at least one of R¹, R² and R⁵ is an —(R³O)ₙR⁴ group; n is an integer between 1 and 11; X is a halide, sulphate, phosphate, nitrate or acetate ion.

4. The composition of claim 1, wherein the at least one acid is selected from the group consisting of phosphoric acid, formic, glycolic, propionic butyric, and acetic acid.

5. The composition of claim 1, wherein the at least one alcohol is selected from the group consisting of methanol and isopropanol.

6. A method for inhibiting the formation of an emulsion between naphthenic acid and metal ions in a hydrocarbon body including contacting a composition including at least one alkoxylated amine in an amount of up to 30% w/w, at least one acid in an amount of from 2 to 10% w/w and at least one alcohol in an amount of from 30 to 70% w/w with the hydrocarbon body simultaneously with or prior to deprotonation of the naphthenic acid.

7. The method of claim 6, wherein the composition is contacted with the hydrocarbon body at a temperature between about 25 and 95° C.

8. The method of claim 6, wherein the at least one alkoxylated amine includes an alkoxylated rosin amine or Rosin Amine D.

9. The method of claim 8, wherein the alkoxylated rosin amine has one or more of the following formulae: 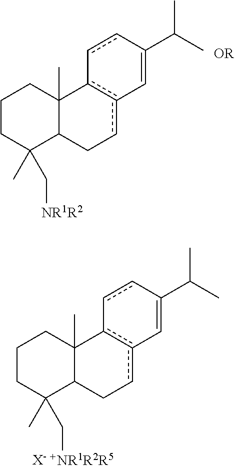
where [symbol] represents a single or double bond; R¹, R² and R⁵ each independently represent H, alkyl, alkenyl or alkynyl group each having between one and ten carbon atoms, —(R³O)ₙR⁴ wherein R³ is an alkyl group having 1 to 3 carbon atoms and R⁴ is H or an alkyl group having 1 to 3 carbon atoms with the proviso that at least one of R¹, R² and R⁵ is an —(R³O)ₙR⁴ group; n is an integer between 1 and 11; X is a halide, sulphate, phosphate, nitrate or acetate ion.

10. The method of claim 6, wherein the at least one acid is selected from the group consisting of phosphoric acid, formic, glycolic, propionic, butyric, and acetic acid.

11. The method of claim 6, wherein the at least one alcohol is selected from the group consisting of methanol and isopropanol.

12. The method of claim 6, wherein the composition is added to the hydrocarbon body in an amount of between about 100 ppm and 1000 ppm.

13. A method for treating a hydrocarbon body downhole including introducing a composition including at least one alkoxylated amine to the hydrocarbon body downhole in an amount sufficient to inhibit sodium carboxylate emulsion formation whilst enabling a shift in pH to above about 6.2 in the hydrocarbon body.

14. The method according to claim 13, wherein the composition includes at least one alkoxylated amine in an amount of up to 30% w/w, at least one acid in an amount of from 2 to 10% w/w and at least one alcohol in an amount of from 30 to 70% w/w.

15. The method of claim 14, wherein the composition is dispersed in the hydrocarbon body.

16. The method of claim 14, wherein the composition is contacted with the hydrocarbon body at a temperature between about 60 and 95° C.

17. The method of claim 14, wherein the at least one alkoxylated amine includes an alkoxylated rosin amine or Rosin Amine D.

18. The method of claim 17, wherein the alkoxylated rosin amine has one or more of the following formulae: 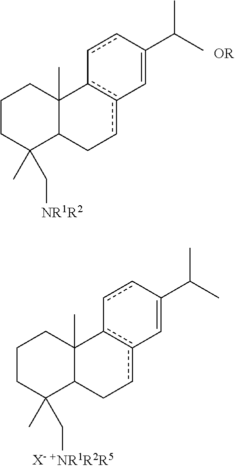
where [symbol] represents a single or double bond; R¹, R² and R⁵ each independently represent H, alkyl, alkenyl or alkynyl group each having between one and ten carbon atoms, —(R³O)ₙR⁴ wherein R³ is an alkyl group having 1 to 3 carbon atoms and R⁴ is H or an alkyl group having 1 to 3 carbon atoms with the proviso that at least one of R¹, R² and R⁵ is an —(R³O)ₙR⁴ group; n is an integer between 1 and 11; X is a halide, sulphate, phosphate, nitrate or acetate ion.

19. The method of claim 14, wherein the at least one acid is selected from the group consisting of phosphoric acid, formic, glycolic, propionic butyric, and acetic acid.

20. The method of claim 14, wherein the at least one alcohol is selected from the group consisting of methanol and isopropanol.

21. The method of claim 14, wherein the composition is added to the hydrocarbon body in an amount of between about 100 ppm and 1000 ppm.
